(19) United States
(12) Patent Application Publication
(10) Pub. No.: US 2015/0316191 A1
(43) Pub. Date: Nov. 5, 2015

(54) DRAINAGE DEVICE

(71) Applicant: Sandro Timarco, Pompano Beach, FL (US)

(72) Inventor: Sandro Timarco, Pompano Beach, FL (US)

(21) Appl. No.: 14/697,734

(22) Filed: Apr. 28, 2015

(30) Foreign Application Priority Data
Apr. 30, 2014 (BR) BR1020140103988

(51) Int. Cl. F16L 41/02; F16L 15/00

(52) U.S. Cl. CPC F16L 41/023; F16L 15/00

(57) ABSTRACT

The present invention refers to a drainage device, particularly a device for water draining from puddles, manhole and flooding and or overflow areas. The device provides an effective water removal and great amounts of puddle water can be removed quickly. The device comprise an equipment which is easy to be assembled and can be fitted to common pumping systems of the art.

### FIELD OF THE INVENTION

The present invention refers to a drainage device, particularly a device for water draining from puddles, manhole and flooding and or overflow areas. The device provides an effective water removal and great amounts of puddle water can be removed quickly. The device comprise an equipment which is easy to be assembled and can be fitted to common pumping systems of the art.

### BACKGROUND OF THE INVENTION

In many urban areas water from rain storms or public water service leaking commonly forms large pools and or puddles which are responsible for urban problems such as urban mobility problems, road accidents and even can contribute for diseases, e.g., dengue, malaria, etc. Normally puddles in urban areas comprise a shallow water surface, but having a large range and the common solution to solve the above mentioned problem comprise to splay water by using brooms and or squeegees and a great amount of people to do it.

This traditional solution is cost intensive and demands time and hard Human work. For example, when an urban overflow occurs the time for accomplish this task is crucial for avoid traffic jam and spread it out for an entire urban way causing a chaotic urban traffic.

Similarly, the manhole maintenance is carried out by using Human work or a suction equipment in a vehicle (a truck). Once more, the above mentioned operation is hard work cost intensive. A collector tank in suction equipment comprises a large size vehicle having a suction pump installed in its truck and having corrugated suction pipes. The size of the collector tank per se cause a partial interruption of the public way (road, street, etc.) due the equipment be positioned close to the manhole. Suction operation depends on the suction pump and considering the maintenance need of a public way or region, this will occur when the collector tank operation is systematically concluded from one manhole to another manhole. In some cases a group of collector tanks are provided for a quick operation. This implies a higher cost if a quick and precise operation is needed and a traffic jam is therefore enhanced. This also implies a road blockage when a group of collectors tanks is employed.

Many art teachings are found in this technical field, but none of taught solutions provide a quick and easy assembling fitted to known pumping systems of the art.

For instance, the patent document U.S. Pat. No. 4,350,591 refers to an apparatus for drilling mud cleaning and comprises a complex equipment which is not able to provide the same solutions of the present invention. The same analysis can be directed to patent documents CH677807A5, U.S. Pat. No. 6,474,958, US2011197939, US2012138706 and US2013340845, which content is entirely incorporated by reference.

### OBJECT OF THE INVENTION

An object of the present invention is to provide a device for eliminate puddles and water accumulation in public ways and comprises an easy and quick assembling equipment which is fitted to all pumping systems known in the art.

Also, the present invention provides a device defining an equipment which is efficiently employed by an user with no expensive and complex assemblage procedure and having a minimum environmental impact when the cleaning is performed and with a minimum interruption for maintenance.

### BRIEF DESCRIPTION OF THE DRAWINGS

FIG. 1 illustrates a longitudinal cut view of the drainage device of the present invention;

FIG. 2A illustrates a second longitudinal cut view of the present invention;

FIG. 2B illustrates a longitudinal cut view and its respective 90° side rotated view of the present invention;

FIG. 3 illustrates a side view of the present invention;

FIG. 4 illustrates another side view of the present invention;

FIG. 5 illustrates a perspective cut view of the present invention; and

FIG. 6 illustrates a perspective view of the present invention.

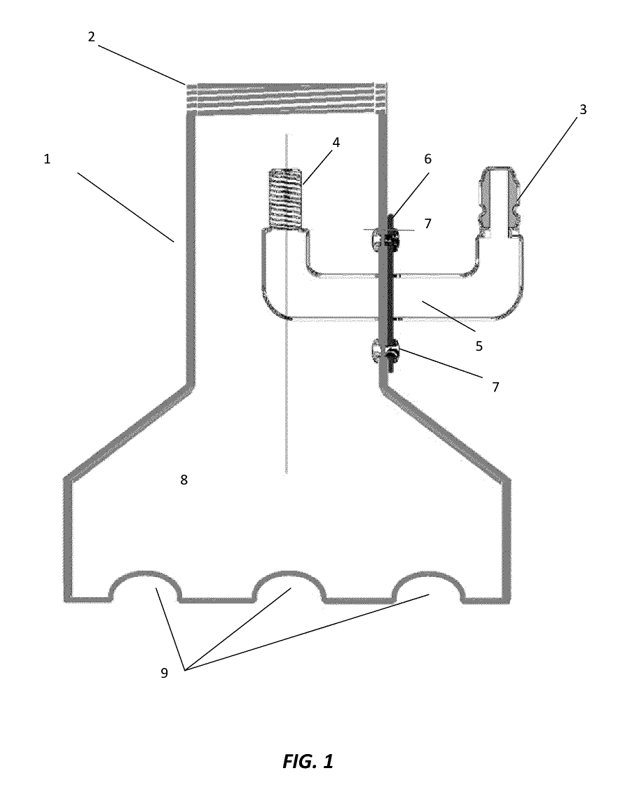

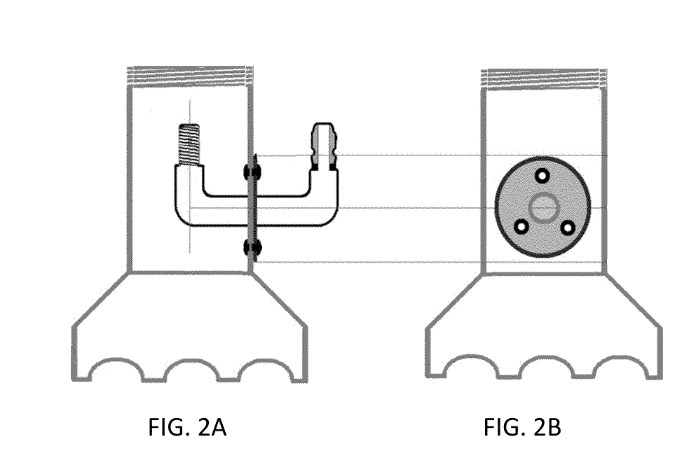

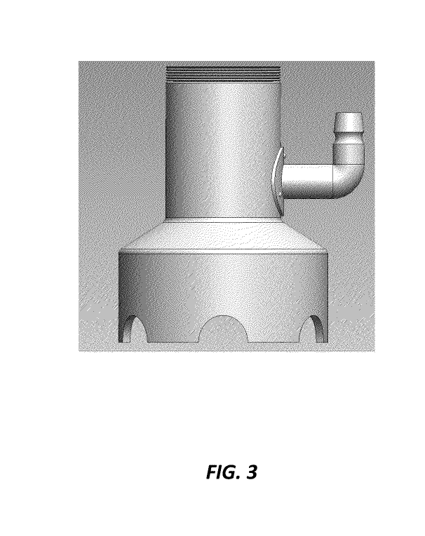

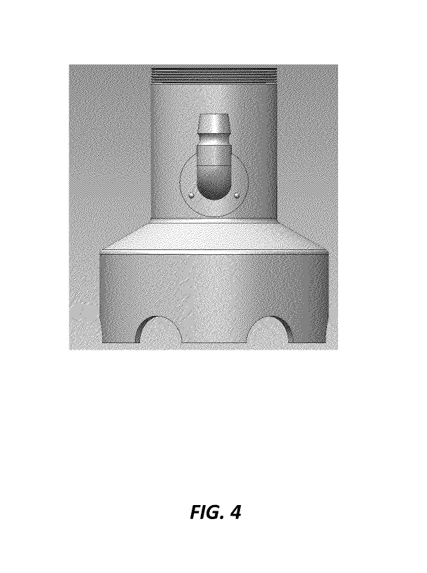

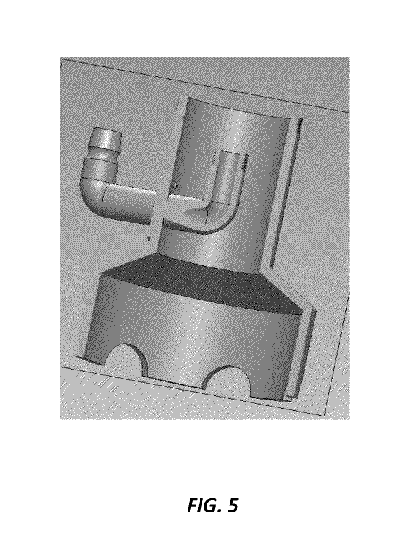

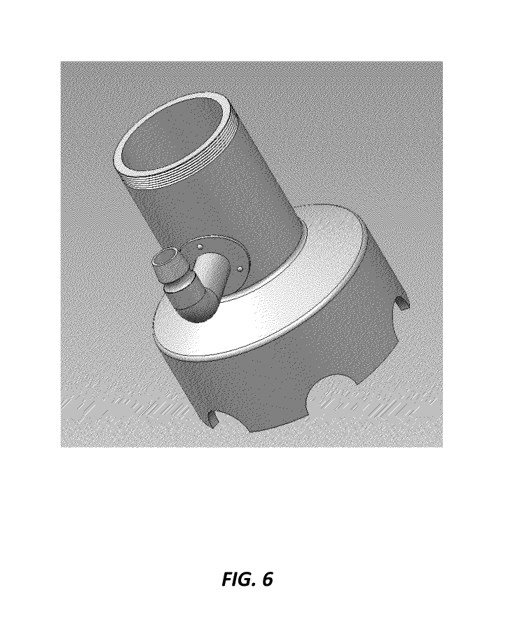

### DETAILED DESCRIPTION OF THE INVENTION

The present invention will be detailed described in connection to the appended figures, but some variations and or modifications can be seen from the present description, but these variations and modifications are included in the claimed scope.

According to the present invention, a device comprise a support tube (1), a screw portion (2) for coupling, a male portion (3) for interlocking, a screw connection (4), a water transport duct (5), a fixation flange (6) of the support tube (7), fixation means (8) and a liquid exhaustion element (9).

The support tube (1) is provided with screw portion (2) in order to permit a connection of the support and other rigid or flexible tube, depending on operational needs. In the inner part of the support tube is provided a transport duct portion (5) having a screw connection (4) in its edge. The transport duct (5) portion externally communicates with a male interlocking portion (3) such as a nipple and the transport duct portion is faced by a fixing flange (6) provided with fixing means (8), for example, rivets.

In the lower part of the present invention device is provided a conical shaped liquid exhaustion element (9) in which semicircular portions (10) are provided in edges of the liquid exhaustion element (9) for receive a water suction flow from a puddle since the suction flow is initiated. The male portion (3) can be conveniently coupled to any pumping equipment for facilitate the invention device use and employability.

Since a pumping equipment is connected, an ascending water flow is initiated inside the invention device (as indicated by arrow D inside the device), i.e., an ascending flowing water.

### EXAMPLE

The following example comprise a preferred embodiment of the present invention, however, any other variations and or modifications are comprised by the claimed invention scope.

According to the Figures, the invention device comprises:

1—A male interlocking tip. The high pressure long pipe quick interlocking jet pistol is coupled to the invention device male interlocking tip.

2—The male interlocking tip is part of an U-shaped tube (U-tube) by which edge a high pressure ascending jet is shot inside the U-tube.

3—In the exhaustion tip is provided a quick interlocking nipple receiving in its coupling tip a water pressure regulating tip through which an ascending high pressure water jet is discharged. The ascending high pressure water jet causes a high atmospheric depression inside the tube and therefore a high ascending suction effect of the puddle liquid through the entire length of the tube conveniently directing the puddle liquid .

The whole device is positioned and fixed in a tube called support tube (s-tube) as set forth. This fixation is performed by means of three (3) rivets circularly positioned at the same distance over a bezant plate which is transversally welded to the invention device body, therefore comprising integrating part of it.

To the s-tube is exactly fixed centered to the exhaustion tip of a 2″¾ external diameter s-tube. In this tube three orifices are provided through which the fixing rivets of the transversal bezant welded to the invention device.

In the lower part of the s-tube is positioned over the ground and immersed in the puddle liquid. This lower part and around the s-tube half orifices are provided for avoid water suction obstruction when the water is suctioned due to the ascending atmospheric depression caused by the high pressure water injected by the jet pistol coupled to the male tip.

The above mentioned s-tube is, in this case a connection sleeve of two other tubes and liquid exhaust.

Performed tests have shown that a pressure provided by a 24 hp Honda engine of a water high pressure compressor, when coupled to the invention device of ascending pressure water jet in a s-tube lower part is able to suck up a water volume corresponding to 3 litres per second.

1. A drainage device comprising:
a support tube (1);
a screw portion (2) located on the support tube;
a fluid transport duct (5) having a first end passing inside the support tube (1) and second end outside the support tube (1);
a screw connection (4) located on the first end of the fluid transport duct;
a male interlocking portion (3) located on the second end of the fluid transport duct;
a fixation flange (6) of a support tube (7);
a fixation device (8); and
a liquid exhaustion element (9) located on a lower section of the support tube.

2. The device, according to claim 1, wherein the support tube (1) is provided with a screw portion (2).

3. The device, according to claim 1, wherein a water transport duct (5) portion is provided inside the support tube (1) and a screw connection (4) is provided in the support tube (1) edge.

4. The device, according to claim 1, wherein the transport duct portion externally communicates with the male portion (3) and it is faced by a fixation flange (6) and joined by means of fixation means (8).

5. The device, according to claim 1, wherein a suction flow rate is about to 3 L/s.
